(19) United States
(12) Patent Application Publication
(10) Pub. No.: US 2024/0388388 A1
(43) Pub. Date: Nov. 21, 2024

(54) TECHNOLOGIES FOR OPERATING TIMERS RELATED TO UPLINK TRANSMISSIONS

(71) Applicant: Apple Inc., Cupertino, CA (US)

(72) Inventors: Ping-Heng Kuo, Greater London (GB); Fangli Xu, Beijing (CN); Zhibin Wu, Los Altos, CA (US); Ralf Rossbach, Munich (DE); Naveen Kumar R. Palle Venkata, San Diego, CA (US); Sethuraman Gurumoorthy, San Ramon, CA (US); Peng Cheng, Beijing (CN); Yuqin Chen, Beijing (CN); Haijing Hu, Los Gatos, CA (US); Alexander Sirotkin, Tel Aviv (IL)

(73) Assignee: Apple Inc., Cupertino, CA (US)

(21) Appl. No.: 18/641,285

(22) Filed: Apr. 19, 2024

Related U.S. Application Data
(60) Provisional application No. 63/467,858, filed on May 19, 2023.

(51) Int. Cl. H04L 1/1867; H04L 1/1812

(52) U.S. Cl. CPC H04L 1/1887; H04L 1/1812

(57) ABSTRACT

The present application relates to devices and components, including apparatus, systems, and methods for selecting timer values and starting or stopping timers related to configured grant or discontinuous reception.

### CROSS-REFERENCES TO OTHER APPLICATIONS

This application claims priority to U.S. Provisional Application No. 63/467,858, for “TECHNOLOGIES FOR OPERATING TIMERS RELATED TO UPLINK TRANSMISSIONS,” filed on May 19, 2023, which is herein incorporated by reference in its entirety for all purposes.

### TECHNICAL FIELD

This application generally relates to cellular communication networks and, in particular, to technologies for operating timers related to uplink transmissions.

### BACKGROUND

In a cellular wireless communication system, user equipment (UE) may utilize several timers to track operations. Some timers may control resource utilization by allowing or preventing the UE from performing some operations. Configuration of timers that improves resource utilization of the system is desired.

### BRIEF DESCRIPTION OF THE DRAWINGS

FIG. 1 illustrates a network environment in accordance with some embodiments.

FIG. 2 illustrates a timing diagram in accordance with some embodiments.

FIG. 3 illustrates a timing diagram in accordance with some embodiments.

FIG. 4 illustrates an operational flow/algorithmic structure in accordance with some embodiments.

FIG. 5 illustrates an operational flow/algorithmic structure in accordance with some embodiments.

FIG. 6 illustrates an operational flow/algorithmic structure in accordance with some embodiments.

FIG. 7 illustrates an operational flow/algorithmic structure in accordance with some embodiments.

FIG. 8 illustrates a user equipment in accordance with some embodiments.

FIG. 9 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

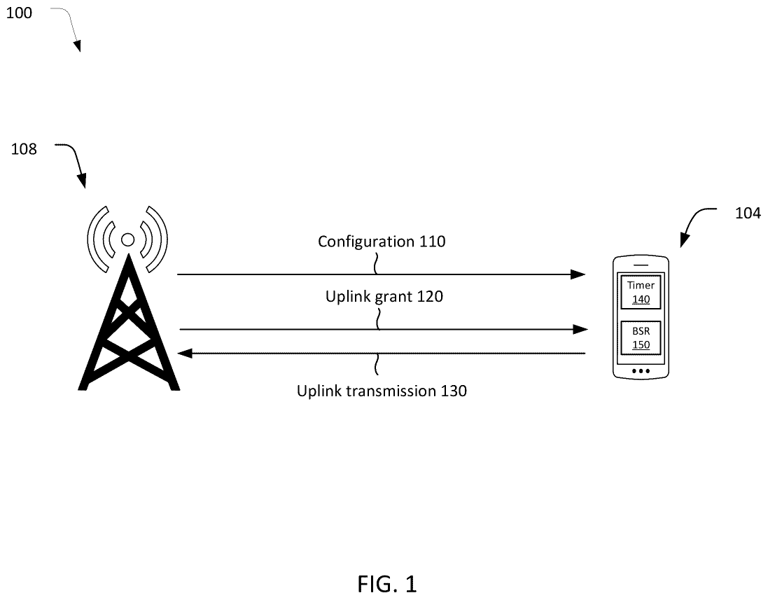

FIG. 1 illustrates a network environment 100 in accordance with some embodiments. The network environment 100 may include a UE 104 coupled with a base station (BS) 108 of a radio access network (RAN). In some embodiments, the BS 108 is a next-generation node B (gNB) that provides one or more 3GPP New Radio (NR) cells. In other embodiments, the BS 108 is an evolved node B (eNB) that provides one or more Long Term Evolution (LTE) cells. The air interface over which the UE 104 and the BS 108 communicate may be compatible with 3GPP technical specifications (TSs), such as those that define Fifth Generation (5G) NR or later system standards (e.g., Sixth Generation (6G) standards).

The BS 108 may send control information to the UEs in downlink control information (DCI) on a physical downlink control channel (PDCCH). The BS 108 may send control information directed to all the UEs in its network or may send dedicated control information directed to a specific UE, e.g., the UE 104. However, the UE 104 may not know its dedicated DCI's location, structure, or scrambling code. The UE 104, therefore, monitors the PDCCH to obtain common or dedicated DCIs. Monitoring the PDCCH is based on a trial and error method such as blind decoding.

The UE 104 may continuously monitor PDCCH even when the BS 108 does not send any data to the UE 104. The continuous monitoring of the PDCCH may consume a significant amount of power, reducing the battery life of the UE 104.

The BS 108 may configure the UE 104 with discontinuous reception (DRX). The DRX allows the UE 104 to periodically enter a DRX inactive mode during the DRX OFF duration or DRX OFF cycle. When in a DRX inactive mode, the UE 104 does not monitor PDCCH. The DRX OFF cycles are known to the BS 108, so the BS 108 may not send any information to the UE 104 during the UE's DRX OFF cycle. When the UE 104 is not in the DRX OFF cycle, it is in the DRX ON cycle or DRX active mode, during which the UE 104 may monitor PDCCH.

The BS 108 may configure the UE 104 with one or more timer 140 associated with the DRX. The BS 108 may use configuration 110 signaling to configure timers 140. In one instance, a timer of one or more timers 140 may track the DRX ON cycle. When this timer expires, the UE 104 may transition to DRX inactive mode. For example, drx-onDurationTimer tracks the DRX ON cycle during which the UE 104 stays active and may monitor PDCCH. If the UE 104 does not receive a PDCCH during DRX ON, it may transition to DRX inactive mode upon expiration of the drx-onDurationTimer. The UE 104 may stay in the DRX inactive mode until the next DRX ON duration starts. The UE 104 may start a round trip time (RTT) timer of one or more timers 140 that tracks the time during which the UE 104 may not expect to receive a DCI from the BS 108 after an UL transmission. For example, the UE 104 may use drx-HARQ-RTT-TimerUL to trach the RTT. The UE 104 may start a retransmission timer of one or more timers 140 to track the time that the UE 104 should monitor PDCCH for a retransmission request associated with an UL transmission. For example, upon expiration of the drx-HARQ-RTT-TimerUL, the UE 104 may start the drx-RetransmissionTimerUL. The UE should be in DRX active mode to monitor PDCCH while the drx-RetransmissionTimerUL is running, and it should return to DRX inactive mode when the drx-RetransmissionTimerUL is expired or stopped or when a retransmission grant is received.

An UL transmission may be associated with a hybrid automatic repeat request (HARQ) process. HARQ process may provide reliable communication by combining error correction and retransmission. For example, the BS 108 may send an UL grant 120 to the UE 104 indicating resources to be used for UL transmission, including a HARQ process identifier (HARQ PID). If an UL transmission is not received by the BS 108, e.g., not successfully decoded, the BS 108 may request a retransmission. For example, the BS 108 may send another UL grant 120 to the UE 104, indicating that no new data should be transmitted and include an indication of the HARQ PID. Therefore, the UE 104 may need to monitor the PDCCH after each UL transmission in case of receiving a retransmission request from the BS 108.

The UL traffic that needs to be transmitted regularly, such as XR pose updates, may require frequent UL scheduling and resource allocation. In one instance, the UE 104 may send a scheduling request for each UL transmission. In response to a scheduling request, the BS 108 would send an UL grant, e.g., by a dynamic UL grant, 120 to allocate resources for the UL transmission 130 or for the transmission of buffer status report (BSR) 150.

In another instance, the BS 108 may allocate resources for more than one UL transmission. In one instance, the BS 108 may allocate UL resources to be used by the UE 104 periodically for UL transmission. For example, the BS 108 may use configured grant (CG) scheduling for UL transmission 130, eliminating the need to schedule requests by the UE 104 and resource assignments by the BS 108 for each UL transmission 130. The BS 108 may send a configuration 110 message, e.g., CG, to the UE 104 to pre-allocate resources to the UE 104 for UL transmission 130. The configuration 110 may allocate one or more HARQ processes to a CG.

In a legacy system, an UL transmission may trigger the UE to start a timer 140, e.g., a CG timer. The UE 104 may start the CG timer on the first orthogonal frequency division multiplexing (OFDM) symbol of the physical uplink shared channel (PUSCH) transmission. The CG timer may be associated with a PUSCH transmission and with the HARQ PID of the PUSCH transmission. While the CG timer associated with a HARQ process is running, the UE may not use CG resources associated with the same HARQ PID.

The UE 104 may send a buffer status report (BSR) 150 to the base station 108 to indicate the amount of uplink data that UE 104 has to transmit. The BSR 150 may be transmitted as a media access control (MAC) control element (CE) on a physical uplink shared channel (PUSCH). The BSR 150 may be associated with a logical channel (LCH) or a logical channel group (LCG) having one or more LCHs. Upon receiving the BSR, the BS 108 may determine an appropriate amount of uplink (UL) resources for the UE 104. The BS 108 may then transmit an uplink grant to the UE 104. The UE 104 may use the UL grant for a subsequent UL transmission.

The UE 104 may transmit a regular BSR, a periodic BSR, or a padding BSR. A regular BSR may be triggered in the event new uplink data of an LCH of an LCG becomes available in a MAC buffer, and either the LCH has a higher priority than any other LCH having buffered data or no other LCH has buffered data. A regular BSR may also be triggered in the event a retransmit BSR timer (retxBSR-Timer) expires and an LCH includes buffered data to be transmitted. The retransmit BSR timer may be used to avoid a deadlock situation that may occur if the base station 108 fails to receive a BSR, but the UE 104 believes the BSR transmission was successful. Thus, the retransmit BSR timer provides a limited period of time for the UE 104 to wait for the uplink grant before retransmitting the BSR. The retransmit BSR timer is started when a BSR is multiplexed into a MAC protocol data unit (PDU).

Existing BSRs only provide information about buffer size. The BSR may further include other buffer delay information to facilitate delay-aware scheduling with latency constraints. For example, the BSR may include an indication of how long the data from one or more LCH has been queued, the amount of time that remains until a delivery deadline of data buffered in one or more LCH, the estimated time until the end of the transmission of a packet, or whether data from one or more logical channel is considered as urgent data. In one instance, an indicator associated with a data unit may determine the urgency level of the data unit.

Different data units may be buffered in the buffer of an LCH or an LCG. For example, the data units may belong to different PDU sets with different delivery deadlines. The data units may arrive at the buffer at different times, e.g., due to jitter. Moreover, data units may be associated with different QoS flows. Data units may be buffered in different LCHs or LCGs with different delay information.

Generally, a data unit may be any portion of the buffered data. In some instances, a data unit may refer to: one packet data convergence protocol (PDCP) service data unit (SDU) or one PDCP PDU, one group of multiple PDCP SDUS or PDCP PDUs, one radio link control (RLC) PDU or RLC SDU, an RLC SDU segment, one group of multiple RLC PDUs, one group of multiple RLS SDUs, one group of RLS SDU segments, one PDU set, one group of PDU sets, or a portion of buffered data associated to a particular QoS flow.

Data units or packets may belong to an important PDU set or a non-important PDU set. In one instance, an indicator associated with a PDU set may determine its importance level.

Consider a CG timer running after an UL transmission on a CG associated with a HARQ process. Further, consider an important or urgent data unit of a delay-sensitive traffic flow buffered for transmission on a CG while the CG timer blocks the CG resources. In some embodiments, the UE 104 may determine that the transmission of important or urgent data may override the CG timer and allocate CG resources for UL transmission, disregarding the CG timer.

The CG timer value, e.g., how long the CG timer should be running after a CG PUSCH transmission, may be pre-configured or fixed. The CG timer may be running even after the delivery of the UL transmission. In another embodiment, the UE 104 may determine that the operation of the CG timer is unnecessary. For example, the duration of the CG timer is unnecessarily long, so the CG timer is set to a different value.

The duration of the DRX retransmission timer may be configured or fixed. In one example, the UL PDU may have reached its delivery deadline before the DRX retransmission timer expires. In one embodiment, the UE 104 may stop the DRX retransmission timer or adjust its duration.

In some embodiments, the UE may select the value of a specific timer that may start with an uplink transmission or stop a running timer even before its expiry. The UE may use the delay information of the data units in LCH buffers or deadlines associated with PDU stored in a HARQ buffer to select the timer value.

The network may configure N timer values or remaining time for delivery of a PDU. When an UL PDU is scheduled for transmission, the UE may select a remaining time or a timer value from the N configured values for the PDU. The UE may multiplex the uplink control information (UCI), including a field indicating the selected value. The selected value may indicate when this UL PDU is considered “outdated” or when the timer started for this UL PDU (e.g., a CG timer or a DRX timer) will be stopped or expired.

The embodiments and examples are applicable to sidelink communication. The DRX timers may be sidelink-specific DRX timers such as drx-RetransmissionTimerSL or drx-HARQ-RTT-TimerSL. Similarly, the embodiments may be applicable to CG retransmission timer, e.g., cg-RetransmissionTimer, or CG short data transmission (SDT) retransmission timer, e.g., cg-SDT-Retransmission Timer.

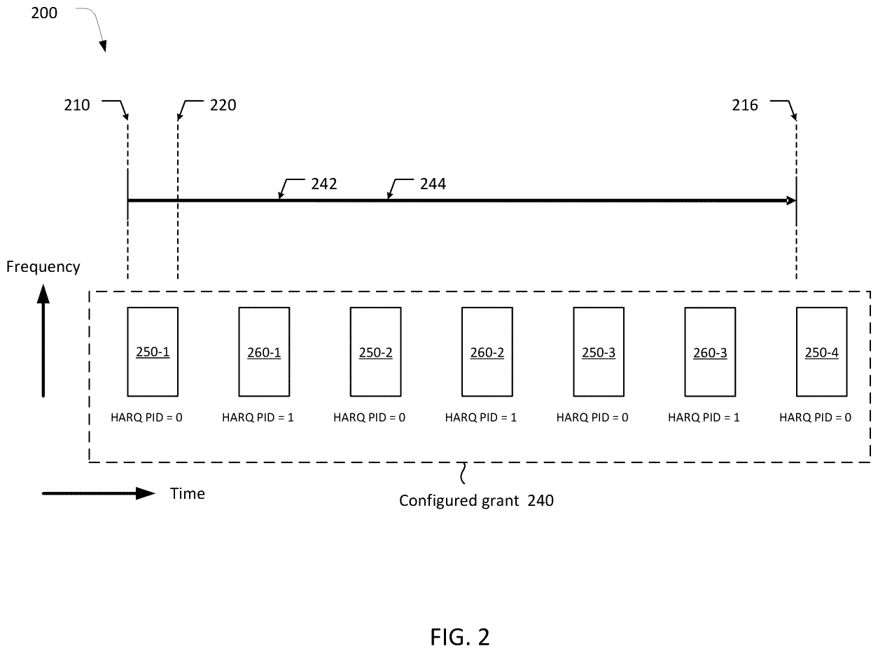

FIG. 2 illustrates a timing diagram 200 in accordance with some embodiments. The timing diagram 200 is an example of a CG 240. The CG 240 may include a plurality of CGs 250-1:4, collectively CGs 250, and 260-1:3, collectively CGs 260. The CGs 250 may include time and frequency resources for PUSCH transmissions that share the same HARQ PID, e.g., HARQ PID=0. The CGs 260 may include time and frequency resources of a subset of CGs that share the same HARQ PID (HARQ PID=1). The CGs 250 may have a different HARQ PID than the CGs 260.

The UE may send a PUSCH transmission within the CG 250-1. The transmitted packet may be associated with the CG 250-1 HARQ process, e.g., HARQ PID=0, and may be stored in a HARQ buffer. In a legacy system, the PUSCH transmission may trigger the UE to start a CG timer. The CG timer may be associated with the PUSCH transmission and with the HARQ PID of the PUSCH transmission. For example, with PUSCH transmission on CG 250-1 at 210, the UE may start a CG timer at time mark 210 or any time between time mark 210 and 220. Where time mark 210 may be the time associated with the first OFDM symbol and 220 the time associated with the last OFDM symbol of the PUSCH transmission. The CG timer may be associated with the HARQ PID of CG 250-1. While the CG timer associated with a HARQ process is running, the UE may not use CG resources associated with the same HARQ PID. For example, consider a PUSCH transmission within CG 250-1. The PUSCH transmission may trigger the CG timer at 210. The CG timer may expire at 216. While the CG timer is running between 210 and 216, the UE may not use UL grants associated with the same HARQ PID as CG 250-1, e.g., HARQ PID=0. Therefore, CGs 250-2 and 250-3 may not be used for UL transmission because the CG timer is running, and CGs 250-2 and 250-3 have the same HARQ PID as CG 250-1. However, once the CG timer expires at 216, CG 250-4 may be used for PUSCH transmission.

Even though the CG timer for the PUSCH transmission at 210 is running, the UE may use CGs 260 for UL transmission. Because the CGs 260 are associated with a HARQ PID that differs from the HARQ PID associated with the CG timer and CG 250-1. Consider that the UE sends an UL PUSCH transmission on CG 260-1 at time mark 220. The UE may start a second CG timer associated with CG 260-1 and its HARQ PID. While the second timer is running, the UE may not use UL grant resources associated with the HARQ PID associated with CG 260-2, i.e., HARQ PID=1. Therefore, the UE may not send a PUSCH transmission associated with HARQ PID=1 at CGs 260-2 or 260-3.

In another example, consider the above example with PUSCH transmission at 210. The transmitted PDU at 210 may be stored in a HARQ buffer associated with the HARQ PID=0. The UE at 242 may determine that a data unit from an LCH has been queueing for a long time, and it is critical for the data to be transmitted. However, the UE may not use the subsequent CG with HARQ PID=0 as the associated CG timer is still running.

In another example, consider the above example with PUSCH transmission at 210. The transmitted PDU at 210 may be stored in a HARQ buffer associated with the HARQ PID=0. The UE at 244 may determine that the delivery deadline of the transmitted PDU at 210 is reached, and the BS has not requested retransmission. Running the CG timer beyond 244 may unnecessarily block the CGs associated with HARQ PID=0.

In one embodiment, the UE may check if the CG timer associated with the HARQ process of the CG is running. If the CG timer is not running, the UE delivers the uplink grant to the HARQ entity for further processing. Otherwise, if the CG timer is running, e.g., an uplink transmission on a CG has initiated the CG timer and the corresponding transmitted PDU is stored in a HARQ buffer. The UE may evaluate whether at least one of the following conditions is met.

The first condition is met when the amount of data from LCH(s) that can be mapped to the CG in the radio link control (RLC) buffer exceeds a volume threshold. The network may configure the volume threshold. For example, the BS may send a radio resource control (RRC) message to configure the volume threshold. The volume threshold may be zero.

The second condition is met when the buffer delay of data from at least one LCH that can be mapped to the CG exceeds a delay threshold. The network may configure the delay threshold. For example, the BS may send an RRC message to configure the delay threshold.

The third condition is met when the remaining time until the delivery deadline of data from at least one LCH that can be mapped to the CG exceeds a time threshold. The network may configure the time threshold. For example, the BS may send an RRC message to configure the delay threshold.

The fourth condition is met when the data from at least one LCH that can be mapped to the CG is considered urgent or critical. A parameter may be associated with the data or the LCH, indicating the level of urgency.

The fifth condition is met when the data from at least one LCH that can be mapped to the CG belongs to a PDU set that has an importance level higher or lower than an importance threshold. A parameter may be associated with the data, the corresponding PDU set, or the LCH, indicating the level of importance. The network may configure the importance threshold. For example, the BS may send an RRC message to configure the importance threshold.

The sixth condition is met when the LCH that can be mapped to the CG has a priority higher than a priority threshold. The network may configure the priority threshold. For example, the BS may send an RRC message to configure the priority threshold.

The seventh condition is met when the buffer delay of data from at least one LCH mapped to the transmitted PDU stored in the HARQ buffer exceeds a delay threshold. The network may configure the delay threshold. For example, the BS may send an RRC message to configure the delay threshold. The delay may be the amount of time the data has arrived from an upper layer or the amount of time the data has been stored in the HARQ buffer.

The eighth condition is met when the remaining time until the delivery deadline of data from at least one LCH mapped to the transmitted PDU stored in the HARQ buffer is less than a time threshold. The network may configure the time threshold. For example, the BS may send an RRC message to configure the time threshold.

The ninth condition is met when the delivery deadline of data—or other data associated with this data, e.g., the data in the same PDU set—from at least one LCH mapped to the transmitted PDU stored in the HARQ buffer is passed. The network may configure the delivery deadline or be defined in the 3GPP Technical Specifications (TSs). For example, the BS may send an RRC message to configure the delivery deadline. The delivery deadline may be implicitly indicated by the discard timer value configured for the data radio bearer of the LCH.

The tenth condition is met when the data from at least one LCH mapped to the transmitted PDU stored in the HARQ buffer belongs to a PDU set with an importance level higher or lower than an importance threshold. The network may configure the importance threshold. For example, the BS may send an RRC message to configure the importance threshold.

In the event that one or more of the ten conditions above are met, the UE may deliver the CG to the HARQ entity for further processing. When an uplink grant is delivered to a HARQ entity, it may mean that the HARQ entity may use the resources specified in the UL grant to transmit data. When the uplink grant is delivered to the HARQ entity for a new transmission, the UE may multiplex uplink control information (UCI) with the new transmission. The UCI may notify the BS that the new transmission overrides the HARQ process. The BS may flush the soft buffer corresponding to the HARQ process. The UE may send the UCI via a separate control channel on the same or a different component carrier. For example, the UE may multiplex the UCI with the new transmission on PUSCH or send the UCI on a physical uplink control channel (PUCCH). With the new transmission, the UE may restart the CG timer.

In another embodiment, the BS may receive delay information of a particular LCH. For example, the BS may receive BSR with delay information. The BS may also receive information on CG resources for transmitting data from the LCH. For example, the BS may configure the UE with LCH mapping restrictions. The BS may receive a PDU corresponding to the LCH on the resources associated with the CG. The BS may successfully decode the PDU and determine that a retransmission of PDU, stored in the HARQ buffer of the UE and soft buffer of the BS, is unnecessary. If retransmission is no longer needed, the BS may provide a dynamic grant (DG) for a new transmission associated with the same HARQ process as the received PDU. The DG may have an explicit indication that instructs the UE to flush the HARQ buffer, stop the running CG timer associated with the PDU, or stop DRX-related timers. The UE receives the DG and may flush the HARQ buffer or stop the running CG timer corresponding to the HARQ process.

In one embodiment, the network may configure the UE with one or more CG timer values. The CG timer value may determine how long the CG timer should be running. The UE may select the CG timer value for an uplink transmission based on the buffer delay information of data in the PDU to be transmitted.

In one embodiment, the UE may be configured to determine the CG timer value when specific LCH or MAC CEs are multiplexed into the PDU for the uplink transmission. The UE may select a default CG timer value when the PDU does not include data from a specific LCH or when the PDU does not include any user data, e.g., only padding BSR MAC CE is included in the PDU.

In one embodiment, the UE may be configured to determine the CG timer value when a condition of buffer status of a specific LCH(s) multiplexed into the PDU for the uplink transmission is satisfied. The buffer status may include buffer size, buffer delay, the remaining time until the deadline, or the presence of data of important PDU sets.

In one embodiment, the UE may select the CG timer value based on the maximum or minimum buffer delay among all or a subset of data units, e.g., MAC SDUs, multiplexed into the PDU.

In one embodiment, the UE may select the CG timer value based on the minimum or maximum remaining time until the deadline among all or a subset of data units, e.g., MAC SDUs, multiplexed into the PDU.

In one embodiment, the UE may select the CG timer value based on the presence or the amount of urgent or critical data units, e.g., MAC SDUs, among all or a subset of data units multiplexed into the PDU.

In one embodiment, the UE may select the CG timer value based on the corresponding LCH priority of all or a subset of data units, e.g., MAC SDUs, multiplexed into the PDU. The corresponding LCH is the LCH whose data is multiplexed into the PDU.

In one embodiment, the UE may select the CG timer value based on the corresponding PDU set importance of all or a subset of data units, e.g., MAC SDUs, multiplexed into the PDU.

In one embodiment, the UE may select a CG timer value equals to zero, which is equivalent to not starting the CG timer with the transmission of the PDU.

In one embodiment, the UE may transmit a PDU, store the PDU in the corresponding HARQ buffer, and start the CG timer associated with a HARQ process. The UE may be prohibited from using the CG resources with the same HARQ process to prevent the UE from overwriting the stored PDU in the HARQ buffer because the stored PDU may be needed for retransmission. While the CG timer is still running, the delivery deadline of the data in the stored PDU may be reached, e.g., the packet delay budget of the data is exceeded. The UE may stop the running CG timer based on delay information of data in the stored PDU.

In one embodiment, the UE may be configured to stop a running CG timer earlier than its default expiry time when specific LCH(s) or MAC CEs are multiplexed into the stored PDU. If the stored PDU does not include any data from specific LCH(s), the UE may not stop the running CG timer early before its expiry. For example, the UE may receive an RRC configuration that enables the UE to stop a running timer early if specific LCH(s) or MAC CEs are multiplexed. Alternatively or additionally, the UE may stop the running CG timer based on the status of another timer, e.g., the DRX timer, associated with the HARQ process of the corresponding HARQ buffer. For example, the CG timer may be stopped when the DRX timer associated with the same HARQ process is stopped or expired.

The UE may evaluate whether at least one of the following conditions is met. In the event that one or more of the conditions below are met, the UE may stop the running CG timer.

The first condition is met when the delivery deadline of at least one, e.g., all or a subset of, data units in the stored PDU has been reached.

The second condition is met when the remaining time until the delivery deadline of at least one, e.g., all or a subset of, data units in the stored PDU is shorter than a deadline threshold. The network may configure the deadline threshold. For example, the BS may send a radio resource control (RRC) message to configure the deadline threshold.

The third condition is met when the shortest remaining time until the delivery deadline among all or a subset of data units in the stored PDU is shorter than a remaining time threshold. The network may configure the remaining time threshold. For example, the BS may send a radio resource control (RRC) message to configure the remaining time threshold.

The fourth condition is met when the stored PDU does not include any data of any important PDU set from at least one, e.g., all or a subset, of LCH(s) or data radio bearers (DRBs).

The fifth condition is met when a DRX timer associated with the HARQ process of the stored PDU is stopped or expired.

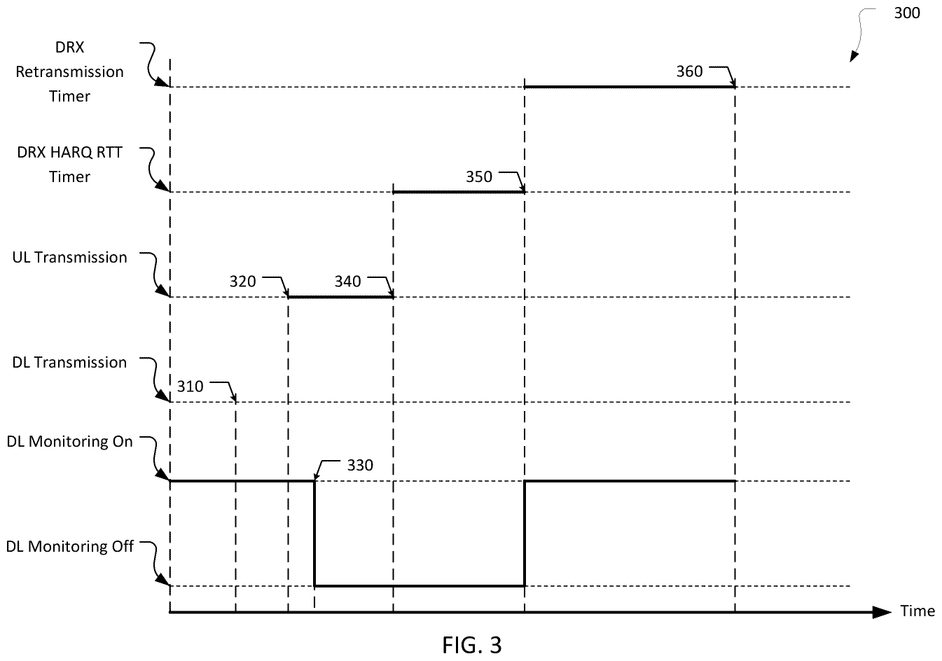

FIG. 3 illustrates a timing diagram 300 in accordance with some embodiments. At 310, the UE receives DCI on the PDCCH during the DRX ON cycle, and the UE may need to stay active for a possible UL or downlink (DL) transmission. The UE may start a timer to track the time during which the UE stays active and monitors the PDCCH. In one instance, the UE may not enter the DRX inactive mode as long as the active timer is running. For example, the drx-Inactivity Timer keeps the UE in an active state after receiving a DCI. The UE may stay in an active state and monitor PDCCH until the expiry of drx-Inactivity Timer.

The received DCI may be associated with an UL transmission. For example, the DCI may include an UL grant, and the UE may transmit data on the PUSCH based on the UL grant. At time mark 320, the UE starts an uplink transmission, e.g., PUSCH transmission, that may last until 340. The UE may enter a DRX OFF cycle at 330.

After the UL transmission by the UE, at 340, it may take some time for the BS to process the UL transmission and send the retransmission request. In some instances, the time needed to receive, process, and respond to an UL (or a DL) transmission may be referred to as round trip time (RTT). The UE may not expect to receive a DCI from the BS during this time. The UE may start a round trip time (RTT) timer that tracks the time during which the UE may not expect to receive a DCI from the BS after an UL transmission. While the round trip timer is running, if the DRX ON timer (e.g., the drx-onDurationTimer) expires, the UE may enter DRX inactive mode. Similarly, while the round trip timer is running, it may remain in that state if the UE is in DRX inactive mode. For example, the UE may start a drx-HARQ-RTT-TimerUL timer at 340 after an UL transmission to track the round trip time. The UE may expect to receive a retransmission request from the BS after the expiration of the drx-HARQ-RTT-TimerUL at 350. Therefore, if the UE makes an UL transmission during the DRX OFF cycle, the UE may remain in the DRX OFF cycle until the expiration of the drx-HARQ-RTT-TimerUL (or until the next DRX ON cycle starts). Upon expiry of the drx-HARQ-RTT-TimerUL, if the UE is still in the DRX OFF cycle, the UE may interrupt the DRX OFF cycle and monitor the PDCCH for a potential retransmission request from the BS.

Once the round trip timer expires, at 350, the UE may start monitoring the PDCCH for a potential retransmission request from the BS. Even if the UE is in DRX inactive mode, the UE may transition to an active state and start monitoring the PDCCH upon the round trip timer expiration. The UE may start a retransmission timer to track the time that the UE should monitor PDCCH for a retransmission request associated with an UL transmission. For example, upon expiration of the drx-HARQ-RTT-TimerUL at 350, the UE may start the drx-RetransmissionTimerUL, which tracks the duration that the UE is required to monitor the PDCCH. Upon expiration of the drx-RetransmissionTimerUL at 360, if the DRX OFF cycle (monitored by another timer) is not expired, the UE may enter (or re-enter) the DRX inactive mode.

In one embodiment, the network may configure the UE with one or more DRX timer values. The DRX timer values may determine how long a DRX timer should be running. The UE may select the DRX timer value based on the buffer delay information of data in the PDU to be transmitted. DRX timer may be a DRX retransmission timer, e.g., drx-retransmissionTimerUL, or a DRX RRT timer, e.g., drx-HARQ-RTT-TimerlUL. In one instance, the UE may select a DRX timer value equal to zero, which is equivalent to not starting the DRX timer with the transmission of the PDU.

In one embodiment, the UE may be configured to determine the DRX timer value when specific LCH or MAC CEs are multiplexed into the PDU for the uplink transmission. The UE may select a default DRX timer value when the PDU does not include data from the specific LCH or when the PDU does not include any user data, e.g., only padding BSR MAC CE is included in the PDU.

In one embodiment, the UE may be configured to determine the DRX timer value when a condition of buffer status of a specific LCH(s) multiplexed into the PDU for the uplink transmission is satisfied. The buffer status may include buffer size, buffer delay, the remaining time until the deadline, or the presence of data of important PDU sets.

In one embodiment, the UE may select the DRX timer value based on the maximum or minimum buffer delay among all or a subset of data units, e.g., MAC SDUs, multiplexed into the PDU.

In one embodiment, the UE may select the DRX timer value based on the minimum or maximum remaining time until the deadline among all or a subset of data units, e.g., MAC SDUs, multiplexed into the PDU.

In one embodiment, the UE may select the DRX timer value based on the presence or the amount of urgent or critical data units, e.g., MAC SDUs, among all or a subset of data units multiplexed into the PDU.

In one embodiment, the UE may select the DRX timer value based on the corresponding LCH priority of all or a subset of data units, e.g., MAC SDUs, multiplexed into the PDU. The corresponding LCH is the LCH whose data is multiplexed into the PDU.

In one embodiment, the UE may select the DRX timer value based on the corresponding PDU set importance of all or a subset of data units, e.g., MAC SDUs, multiplexed into the PDU.

In one embodiment, the UE may transmit a PDU, start a DRX timer, and store the PDU in the corresponding HARQ buffer. The UE may stop the running DRX timer based on delay information of data in the stored PDU. Alternatively or additionally, the UE may stop the running DRX timer based on the status of another timer, e.g., CG timer, associated with the HARQ process of the corresponding HARQ buffer. For example, the DRX timer may be stopped when the CG timer associated with the same HARQ process is stopped or expired. When the DRX timer is stopped, the UE may terminate a DRX active mode or enter DRX inactive mode.

In one embodiment, the UE may be configured to stop a running DRX timer when specific LCH(s) or MAC CEs are multiplexed into the stored PDU. If the stored PDU does not include any data from specific LCH(s), the UE may not stop the running DRX timer early before its expiry. For example, the UE may receive an RRC configuration that enables the UE to stop a running DRX timer.

The UE may evaluate whether at least one of the following conditions is met. In the event that one or more of the conditions below are met, the UE may stop the running DRX timer earlier than its default expiry time. The running DRX timer can be either a DRX retransmission timer or a DRX HARQ RTT timer.

The first condition is met when the delivery deadline of at least one, e.g., all or a subset of, data units in the stored PDU has been reached.

The second condition is met when the remaining time until the delivery deadline of at least one, e.g., all or a subset of, data units in the stored PDU is shorter than a deadline threshold. The network may configure the deadline threshold. For example, the BS may send a radio resource control (RRC) message to configure the deadline threshold.

The third condition is met when the shortest remaining time until the delivery deadline among all or a subset of data units in the stored PDU is shorter than a remaining time threshold. The network may configure the remaining time threshold. For example, the BS may send a radio resource control (RRC) message to configure the remaining time threshold.

The fourth condition is met when the stored PDU does not include any data of any important PDU set from at least one, e.g., all or a subset, of LCH(s) or data radio bearers (DRBs).

The fifth condition is met when a CG timer associated with the HARQ process of the stored PDU is stopped or expired.

In one embodiment, if the UE stops a DRX HARQ RTT timer, e.g., drx-HARQ-RTT-TimerUL, before its expiry, the UE may also refrain from starting the following DRX retransmission timer, e.g., drx-RetransmissionTimerUL.

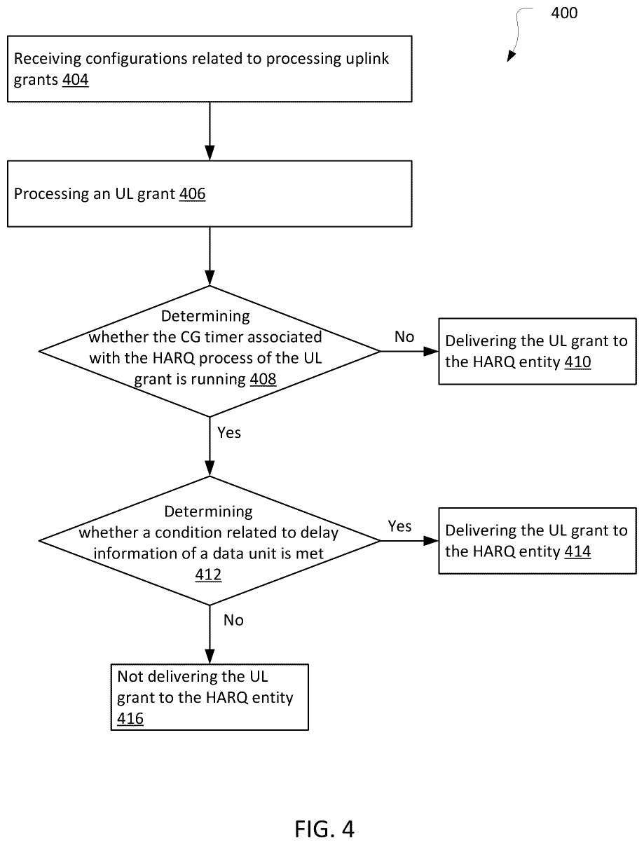

FIG. 4 illustrates an operational flow/algorithmic structure 400 in accordance with some embodiments. Operational flow/algorithmic structure 400 is an example of a method to be implemented by a UE to deliver a CG to the corresponding HARQ process. The operational flow/algorithmic structure 400 may be implemented by a UE, for example, the UE 104, the UE 800, or components therein, e.g., processors 804.

The operational flow/algorithmic structure 400 may include, at 404, receiving configurations related to processing uplink grants. The UE may receive a configuration to enable the UE to deliver an uplink grant to a HARQ entity based on a condition of delay information of a data unit. The data unit may be associated with the last transmission whose PDU is stored in the HARQ buffer or associated with the upcoming transmissions. Delivering the uplink grant to the HARQ entity may override the HARQ process and disregard a running timer, preventing the UE from delivering the UL grant to the HARQ entity.

The operational flow/algorithmic structure 400 may include, at 406, processing a CG. The CG may be associated with a HARQ PID. In one instance, operational flow/algorithmic structure 400 may include, at 406, processing an UL grant, e.g., a dynamic grant or a CG.

The operational flow/algorithmic structure 400 may include, at 408, determining whether the CG timer associated with the HARQ process of the CG is running. A running CG timer may indicate that there has been an UL transmission on a CG associated with the same HARQ PID, and a corresponding PDU is stored in a HARQ buffer. If the CG timer associated with the HARQ process of the CG is not running, the operational flow/algorithm structure 400 may proceed to 410. However, if the CG timer associated with the HARQ process of the CG is running, the operational flow/algorithm structure 400 may proceed to 412.

The operational flow/algorithmic structure 400 may include, at 410, delivering the CG to the HARQ entity. When there is no running CG timer associated with the HARQ process, the CG resources are available for UL transmission, and UE may deliver the CG to the HARQ entity.

The operational flow/algorithmic structure 400 may include, at 412, determining whether a condition related to delay information of a data unit in the HARQ buffer is met. The condition of the delay information of the data unit may include an amount of data from a logical channel associated with the CG being larger than a volume threshold, a buffer delay of data from a logical channel associated with the CG being larger than a delay threshold; a remaining time until a delivery deadline of data from a logical channel associated with the CG being smaller than a time threshold; data, from a logical channel associated with the CG, being urgent data; data, from a logical channel associated with the CG, being associated with a packet data unit (PDU) set with an importance level larger than an importance threshold; priority of a logical channel associated with the CG being larger than a priority threshold; or a delivery deadline of data, from a logical channel associated with the CG, being expired. If no condition related to delay information of a data unit is met, the operational flow/algorithm structure 400 may proceed to 414. However, if a condition related to delay information of a data unit is met, the operational flow/algorithm structure 400 may proceed to 416.

The operational flow/algorithmic structure 400 may include, at 414, delivering the CG to the HARQ entity.

The operational flow/algorithmic structure 400 may include, at 416, not delivering the CG to the HARQ entity.

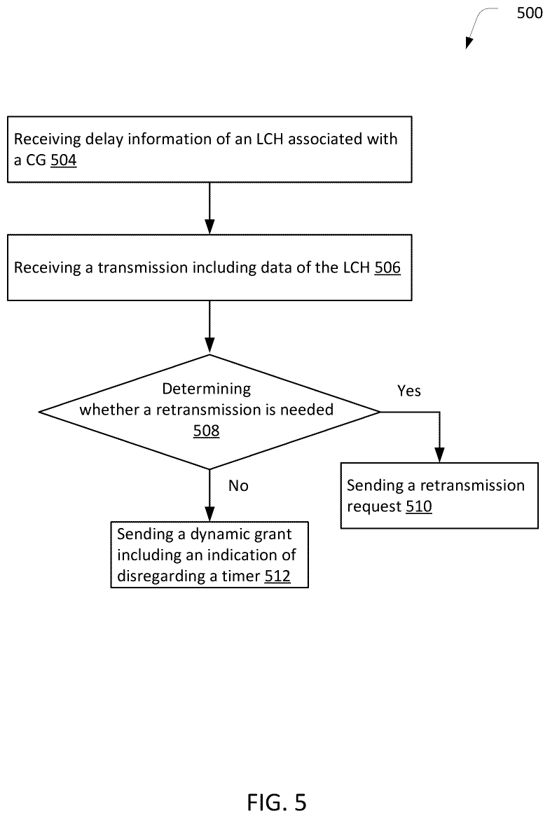

FIG. 5 illustrates an operational flow/algorithmic structure 500 in accordance with some embodiments. Operational flow/algorithmic structure 500 is an example of a method to be implemented by a BS to overwrite a HARQ process at a UE based on the delay information of the UE. The operational flow/algorithmic structure 500 may be implemented by a BS, for example, the BS 108, the BS 900, or components therein, e.g., processors 904.

The operational flow/algorithmic structure 500 may include, at 504, receiving delay information of an LCH where the LCH is associated with a CG.

The operational flow/algorithmic structure 500 may include, at 506, receiving a transmission including data of the LCH. The transmission may be associated with a HARQ PID and indicate that a CG timer associated with the CG is running at the UE.

The operational flow/algorithmic structure 500 may include, at 508, determining whether a retransmission is needed. The BS may decode the received data. Successful decoding of the received data may not require retransmission of the data by the UE. However, if the BS cannot decode the received data, the BS may request the UE to retransmit the data. If the BS determines that retransmission is needed, the flow/algorithm structure 500 proceeds to 510. If the BS determines that retransmission is not required, the flow/algorithm structure 500 proceeds to 512.

The operational flow/algorithmic structure 500 may include, at 510, sending a retransmission request to the UE.

The operational flow/algorithmic structure 500 may include, at 512, sending a dynamic grant associated with the HARQ PID and an indication of disregarding a timer associated with the CG or a timer associated with the HARQ PID. The dynamic grant may include instructions on stopping the timer associated with the CG or the HARQ PID.

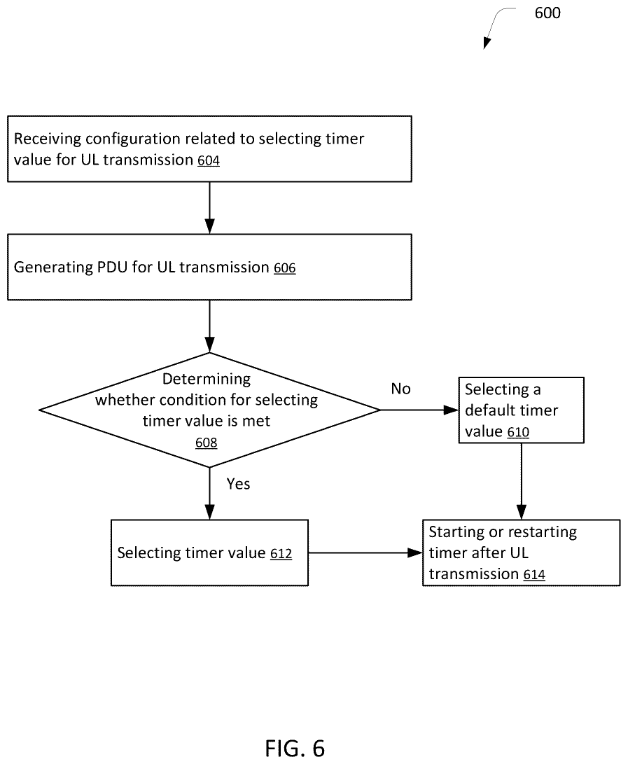

FIG. 6 illustrates an operational flow/algorithmic structure 600 in accordance with some embodiments. Operational flow/algorithmic structure 600 is an example of a method to be implemented by a UE to select a timer value based on the buffer delay information. The operational flow/algorithmic structure 600 may be implemented by a UE, for example, the UE 104, the UE 800, or components therein, e.g., processors 804.

The operational flow/algorithmic structure 600 may include, at 604, receiving configurations related to selecting a timer value for UL transmission. The UE may receive a configuration to enable the UE to select a timer value based on the delay information of a data unit or a condition. The data unit may be associated with the upcoming transmissions. The timer value may be associated with a CG timer or a DRX-related timer, e.g., DRX HARQ RTT timer or DRX retransmission timer.

The operational flow/algorithmic structure 600 may include, at 606, generating a PDU for the UL transmission. The PDU may include one or more data units.

The operational flow/algorithmic structure 600 may include, at 608, determining whether the condition for selecting the timer value is met. When the condition is not met, the operational flow/algorithmic structure 600 proceeds to 610. If the condition is met, the operational flow/algorithmic structure 600 proceeds to 612. The condition includes: the PDU includes data from the first LCH; the PDU includes urgent data, the PDU includes data from a second LCH with a priority larger than a priority threshold or an importance level associated with the PDU being larger than an importance threshold.

The operational flow/algorithmic structure 600 may include, at 610, selecting a default timer value. The UE may select the timer value from one or more values configured by the BS.

The operational flow/algorithmic structure 600 may include, at 612, selecting a timer value based on the delay information of the data unit in the PDU. Delay information may include the maximum or minimum buffer delay of data units in the PDU or the minimum or maximum remaining time until the deadline of data units in the PDU. The operational flow/algorithmic structure 600 may proceed to 614 from 610 or 612.

The operational flow/algorithmic structure 600 may include, at 614, starting or restarting the timer after the UL transmission.

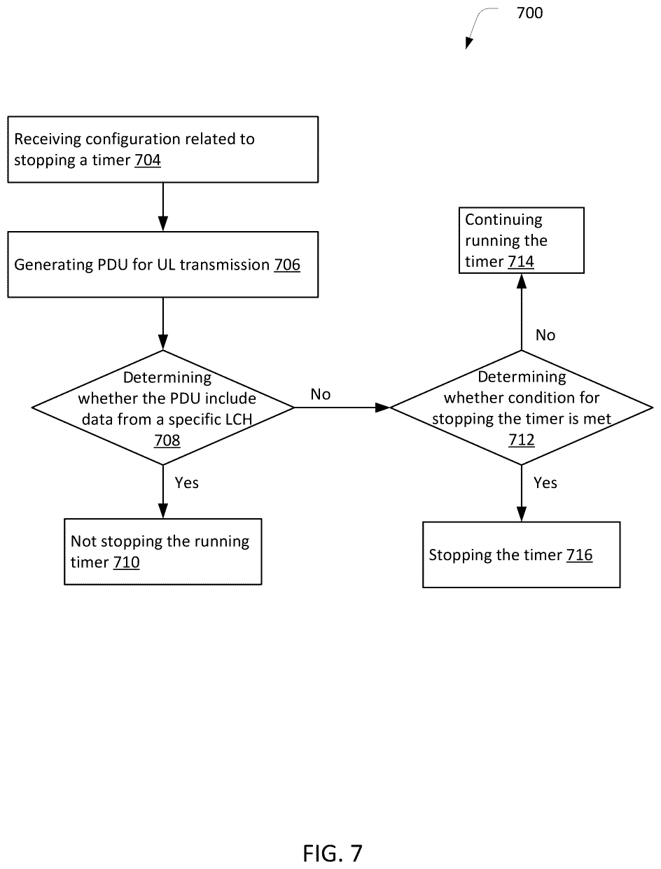

FIG. 7 illustrates an operational flow/algorithmic structure 700 in accordance with some embodiments. Operational flow/algorithmic structure 700 is an example of a method to be implemented by a UE to stop a timer based on the buffer delay information of a stored PDU. The operational flow/algorithmic structure 700 may be implemented by a UE, for example, the UE 104, the UE 800, or components therein, e.g., processors 804.

The operational flow/algorithmic structure 700 may include, at 704, receiving configurations related to selecting a timer value for UL transmission. The UE may receive a configuration to enable the UE to stop a timer based on a condition or delay information of a data unit. The data unit may be associated with a PDU stored in the HARQ buffer. The timer may be a CG timer or a DRX-related timer, e.g., a DRX HARQ RTT timer or DRX retransmission timer.

The operational flow/algorithmic structure 700 may include, at 706, generating a PDU for UL transmission. The PDU may be created by multiplexing one or more data units, and each data unit may be associated with an LCH. The UE may transmit the PDU in the uplink transmission, start a timer associated with the uplink transmission, and store the PDU in a HARQ buffer.

The operational flow/algorithmic structure 700 may include, at 708, determining whether the stored PDU includes data from a specific LCH. The UE may be configured with an indication of the specific LCH. For example, the UE may receive an RRC message, including an indication of the specific LCH. If the stored PDU includes data from the specific LCH, the operational flow/algorithmic structure 700 proceeds to 710. If the stored PDU does not include data from the specific LCH, the operational flow/algorithmic structure 700 proceeds to 712.

The delay information may include a delivery deadline of a data unit of the one or more data units in the PDU; a remaining time until a delivery deadline of the data unit of the one or more data units in the PDU; or the shortest or longest remaining time until the delivery deadline of the data unit of the one or more data units in the PDU.

The operational flow/algorithmic structure 700 may include, at 710, not stopping the running timer.

The operational flow/algorithmic structure 700 may include, at 712, determining whether the condition for stopping the timer is met. The condition may include: the stored PDU does not include a data unit from the specific LCH, or the data unit in one or more data units is not associated with a PDU set with an importance level smaller than a threshold or not associated with the importance level. If the condition for stopping the timer is met, the operational flow/algorithmic structure 700 proceeds to 716. If the condition for stopping the timer is not met, the operational flow/algorithmic structure 700 proceeds to 714.

The operational flow/algorithmic structure 700 may include, at 714, continuing running the timer.

The operational flow/algorithmic structure 700 may include, at 716, stopping the timer.

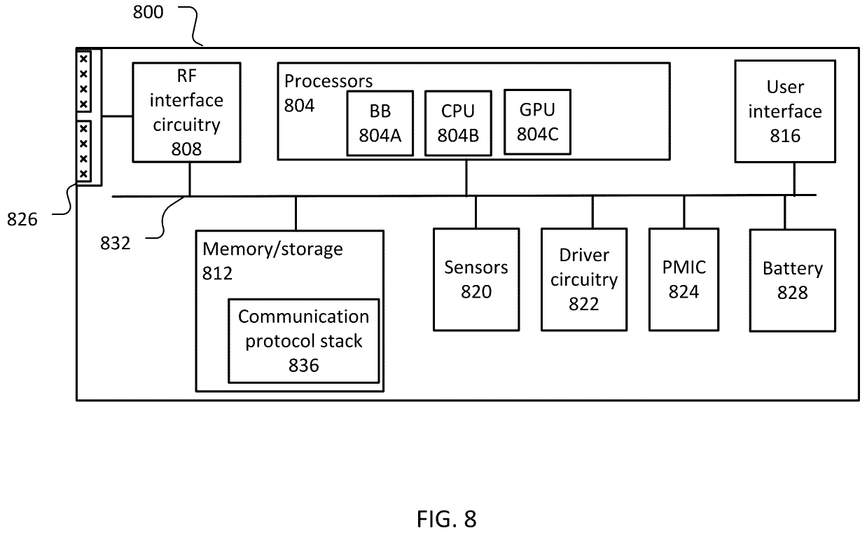

FIG. 8 illustrates a UE 800 in accordance with some embodiments. The UE 800 may be similar to and substantially interchangeable with UE 104 of FIG. 1.

The UE 800 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 800 may include processors 804, RF interface circuitry 808, memory/storage 812, user interface 816, sensors 820, driver circuitry 822, power management integrated circuit (PMIC) 824, antenna structure 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangements of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein.

The processors 804 may perform operations associated with selecting timer value and starting or stopping CG-related or DRX-related timers consistent with embodiments described herein.

In some embodiments, the baseband processor circuitry 804A may access a communication protocol stack 836 in the memory/storage 812 to communicate over a 3GPP-compatible network. In general, the baseband processor circuitry 804A may access the communication protocol stack 836 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 812 may include one or more non-transitory, computer-readable media that include instructions (for example, the communication protocol stack 836) that may be executed by one or more of the processors 804 to cause the UE 800 to perform various operations described herein. The memory/storage 812 includes any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 808 may include transceiver circuitry and a radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 826 and proceed to filter and amplify (with a low-noise amplifier) the signal. The signal may be provided to a receiver of the transceiver that down-converts the RF signal into a baseband signal that is provided to the baseband processor of the processor 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and convert received radio waves into electrical signals. The antenna elements may be arranged into one or more antenna panels. The antenna 826 may have antenna panels that are omnidirectional, directional, or a combination thereof to enable beamforming and multiple input, multiple output communications. The antenna 826 may include microstrip antennas, printed antennas fabricated on the surface of one or more printed circuit boards, patch antennas, or phased array antennas. The antenna 826 may have one or more panels designed for specific frequency bands, including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various I/O devices that may be present within or connected to the UE 800. For example, the driver circuitry 822 may include circuitry to facilitate the coupling of a universal integrated circuit card (UICC) or a universal subscriber identity module (USIM) to the UE 800. For additional examples, driver circuitry 822 may include a display driver to control and allow access to a display device, a touchscreen driver to control and allow access to a touchscreen interface, sensor drivers to obtain sensor readings of sensor circuitry 820, and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage the power provided to various components of the UE 800. In particular, with respect to the processors 804, the PMIC 824 may control power-source selection, voltage scaling, battery charging, or DC-to-DC conversion.

In some embodiments, the PMIC 824 may control or otherwise be part of various power-saving mechanisms of the UE 800, including DRX, as discussed herein.

A battery 828 may power the UE 800, although, in some examples, the UE 800 may be mounted and deployed in a fixed location and may have a power supply coupled to an electrical grid. The battery 828 may be a lithium-ion battery, a metal-air battery, such as a zinc-air battery, an aluminum-air battery, a lithium-air battery, and the like. In some implementations, such as in vehicle-based applications, the battery 828 may be a typical lead-acid automotive battery

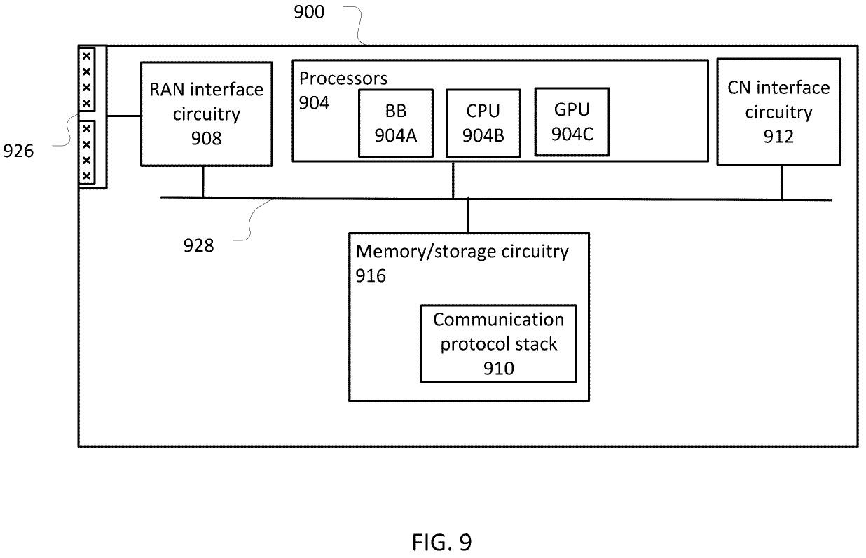

FIG. 9 illustrates a network node 900 in accordance with some embodiments. The network node 900 may be similar to and substantially interchangeable with base station 108, a device implementing one of the network hops, an integrated access and backhaul (IAB) node, a network-controlled repeater, or a server in a core network or external data network.

The network node 900 may include processors 904, RF interface circuitry 908 (if implemented as an access node), the core node (CN) interface circuitry 912, memory/storage circuitry 916, and antenna structure 926.

The components of the network node 900 may be coupled with various other components over one or more interconnects 928.

The processors 904, RF interface circuitry 908, memory/storage circuitry 916 (including communication protocol stack 910), antenna structure 926, and interconnects 928 may be similar to the like-named elements shown and described with respect to FIG. 8.

The processors 904 may perform operations associated with selecting timer value starting or stopping CG-related or DRX-related timers consistent with the embodiments described herein.

The CN interface circuitry 912 may provide connectivity to a core network, for example, a 5th Generation Core network (5GC) using a 5GC-compatible network interface protocol such as carrier Ethernet protocols or some other suitable protocol. Network connectivity may be provided to/from the network node 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

In some embodiments, the network node 900 may be coupled with transmit-receive points (TRPs) using the antenna structure 926, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method to be implemented by a user equipment (UE), the method including: receiving a configuration to enable the UE to deliver an uplink grant to a hybrid automatic repeat request (HARQ) entity based on a condition of delay information of a data unit; processing a configured grant (CG) associated with a HARQ process identifier (HARQ PID); determining whether a CG timer associated with the HARQ PID is running; determining whether the condition of the delay information of the data unit is met; and determining, based on said determining whether the condition of the delay information of the data unit is met, whether to deliver the CG to the HARQ entity.

Example 2 includes the method of example 1 or some other examples herein, wherein said determining whether the condition of the delay information of the data unit is met comprises determining the condition of the delay information of the data unit is met and the method further includes: delivering the CG to the HARQ entity.

Example 3 includes the method of examples 1 or 2 or some other examples herein, wherein the condition of the delay information of the data unit includes: an amount of data from a logical channel associated with the CG being larger than a volume threshold; a buffer delay of data from a logical channel associated with the CG being larger than a delay threshold; a remaining time until a delivery deadline of data from a logical channel associated with the CG being smaller than a time threshold; data, from a logical channel associated with the CG, being urgent data; data, from a logical channel associated with the CG, being associated with a packet data unit (PDU) set with an importance level larger than an importance threshold; priority of a logical channel associated with the CG being larger than a priority threshold; or a delivery deadline of data, from a logical channel associated with the CG, being expired.

Example 4 includes the method of any of examples 1-3 or some other examples herein, wherein the data unit is a first data unit from the logical channel (LCH) or a second data unit associated with the LCH and stored in a buffer of the HARQ entity.

Example 5 includes the method of any of examples 1-4 or some other examples herein, further including: sending uplink control information (UCI) to indicate that a HARQ process associated with the HARQ PID is overridden.

Example 6 includes the method of any of examples 1-5 or some other examples herein, wherein the configuration is included in a radio resource control (RRC) message.

Example 7 includes a method to be implemented by a base station (BS), the method including: receiving, from a user equipment (UE), delay information of a logical channel (LCH); receiving, from the UE, a transmission including data of the LCH, the transmission associated with a hybrid automatic repeat request (HARQ) process identifier (ID); determining whether a retransmission is needed; and sending, to the UE, a dynamic grant associated with the HARQ PID, the dynamic grant including an indication of disregarding a timer associated with a configured grant or a HARQ process associated with the HARQ PID.

Example 8 includes the method of example 7 or some other examples herein, wherein the dynamic grant is to include an instruction to flush a HARQ buffer associated with the HARQ PID.

Example 9 includes the method of examples 7 or 8 or some other examples herein, wherein the dynamic grant is to include an instruction to stop the timer associated with a configured grant or the HARQ PID.

Example 10 includes a method to be implemented by a user equipment (UE), the method including: receiving a configuration to enable the UE to select a value of a timer based on a condition or buffer delay information of data to be transmitted by an uplink transmission; generating a packet data unit (PDU) for the uplink transmission; and selecting the value of the timer based on the buffer delay information of the PDU.

Example 11 includes the method of example 10 or some other examples herein, wherein the timer is a configured grant timer, a discontinuous reception (DRX) retransmission timer for uplink, or a DRX round trip time timer for uplink.

Example 12 includes the method of examples 10 or 11 or some other examples herein, wherein the configuration includes an indication of a first logical channel (LCH), and the condition includes, the condition includes: the PDU includes data from the first LCH; the PDU includes urgent data; the PDU includes data from a second LCH with a priority larger than a priority threshold; or an importance level associated with the PDU being larger than an importance threshold.

Example 13 includes the method of any of examples 10-12 or some other examples herein, wherein the buffer delay information is to include: maximum or minimum buffer delay of data units in the PDU; or minimum or maximum remaining time until a deadline of data units in the PDU.

Example 14 includes the method of any of examples 10-13 or some other examples herein, further including: receiving one or more timer values, wherein said selecting the value of the timer comprises selecting the value of the timer from the one or more timer values.

Example 15 includes the method of any of examples 10-14 or some other examples herein, further including: generating an uplink control message, including an indication of the value of the timer; and sending the uplink control message to a base station (BS).

Example 16 includes a method of operating a user equipment (UE), the method including: receiving a configuration to enable the UE to stop a timer based on a condition or buffer delay information associated with a stored packet data unit (PDU); generating the PDU from one or more data units associated with an uplink transmission; transmitting the PDU in the uplink transmission; starting the timer; storing the PDU in a hybrid automatic repeat request (HARQ) buffer; and stopping the timer based on the buffer delay information of the one or more data units in the PDU.

Example 17 includes the method of example 16 or some other examples herein, wherein the timer is a configured grant timer, a discontinuous reception (DRX) retransmission timer for uplink, or a DRX round trip time timer for uplink.

Example 18 includes the method of examples 16 or 17 or some other examples herein, wherein the configuration includes an indication of a logical channel (LCH), and the condition include, the condition includes: the PDU includes a data unit from the LCH; or the data unit in one or more data units is associated with a PDU set with an importance level smaller than a threshold or not associated with the importance level.

Example 19 includes the method of any of examples 16-18 or some other examples herein, wherein the buffer delay information is to include: a delivery deadline of a data unit of the one or more data units in the PDU; a remaining time until a delivery deadline of the data unit of the one or more data units in the PDU; or a shortest remaining time until the delivery deadline of the data unit of the one or more data units in the PDU.

Example 20 includes the method of any of examples 16-19 or some other examples herein, further comprising: generating an uplink control message, including an indication of stopping the timer; and sending the uplink control message to a base station (BS).

Another example may include an apparatus comprising logic, modules, or circuitry to perform one or more elements of a method described in or related to any of examples 1-20 or any other method or process described herein.

Another example may include a method, technique, or process as described in or related to any of examples 1-20 or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example includes a signal as described in or related to any of examples 1-20 or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20 or portions thereof.

Another example may include a signal in a wireless network, as shown and described herein.

Another example may include a method of communicating in a wireless network, as shown and described herein.

Another example may include a system for providing wireless communication, as shown and described herein.

Another example may include a device for providing wireless communication, as shown and described herein.

Any of the above-described examples may be combined with any other example (or combination of examples) unless explicitly stated otherwise. The foregoing description of one or more implementations provides illustration and description but is not intended to be exhaustive or to limit the scope of aspects to the precise form disclosed. Modifications and variations are possible in light of the above teachings or may be acquired from the practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a configuration to enable a determination of whether to deliver an uplink grant to a hybrid automatic repeat request (HARQ) entity based on a condition of delay information of a data unit;
processing a configured grant (CG) associated with a HARQ process identifier (HARQ PID);
determining whether a CG timer associated with the HARQ PID is running;
determining whether the condition of the delay information of the data unit is met; and
determining, based on said determining whether the condition of the delay information of the data unit is met, whether to deliver the CG to the HARQ entity.

2. The method of claim 1, wherein said determining whether the condition of the delay information of the data unit is met comprises determining the condition of the delay information of the data unit is met and the method further comprises:
delivering the CG to the HARQ entity.

3. The method of claim 1, wherein the condition of the delay information of the data unit comprises:
an amount of data from a logical channel associated with the CG being larger than a volume threshold;
a buffer delay of data from a logical channel associated with the CG being larger than a delay threshold;
a remaining time until a delivery deadline of data from a logical channel associated with the CG being smaller than a time threshold;
data, from a logical channel associated with the CG, being urgent data;
data, from a logical channel associated with the CG, being associated with a packet data unit (PDU) set with an importance level larger than an importance threshold;
priority of a logical channel associated with the CG being larger than a priority threshold; or
a delivery deadline of data, from a logical channel associated with the CG, being expired.

4. The method of claim 3, wherein the data unit is a first data unit from the logical channel (LCH) or a second data unit associated with the LCH and stored in a buffer of the HARQ entity.

5. The method of claim 1, further comprising:
generating uplink control information (UCI) to indicate that a HARQ process associated with the HARQ PID is overridden.

6. The method of claim 1, wherein the configuration is included in a radio resource control (RRC) message.

7. A method comprising:
processing delay information of a logical channel (LCH) received from a user equipment (UE);
processing a transmission received from the UE including data of the LCH, the transmission associated with a hybrid automatic repeat request (HARQ) process identifier (HARQ PID);
determining whether a retransmission is needed; and
generating a dynamic grant associated with the HARQ PID to be transmitted to the UE, the dynamic grant including an indication of disregarding a timer associated with a configured grant or a HARQ process associated with the HARQ PID.

8. The method of claim 7, wherein the dynamic grant is to include an instruction to flush a HARQ buffer associated with the HARQ PID.

9. The method of claim 7, wherein the dynamic grant is to include an instruction to stop the timer associated with a configured grant or the HARQ PID.

10. A baseband processor comprising:
processing circuitry configured to:
process a configuration, received from a base station, the configuration is to enable selection of a value of a timer based on a condition or buffer delay information of data to be transmitted by an uplink transmission;
generating a packet data unit (PDU) for the uplink transmission; and
selecting the value of the timer based on the buffer delay information of the PDU or the condition; and
interface circuitry to communicatively couple the processing circuitry to a component of a device.

11. The baseband processor of claim 10, wherein the timer is a configured grant timer, a discontinuous reception (DRX) retransmission timer for uplink, or a DRX round trip time timer for uplink.

12. The baseband processor of claim 10, wherein the configuration includes an indication of a first logical channel (LCH), and the condition includes:
the PDU includes data from the first LCH;
the PDU includes urgent data;
the PDU includes data from a second LCH with a priority larger than a priority threshold; or
an importance level associated with the PDU being larger than an importance threshold.

13. The baseband processor of claim 10, wherein the buffer delay information is to include:
maximum or minimum buffer delay of data units in the PDU; or
minimum or maximum remaining time until a deadline of data units in the PDU.

14. The baseband processor of claim 10, wherein the processing circuitry is configured further to:
receive one or more timer values, wherein said select the value of the timer comprises to select the value of the timer from the one or more timer values.

15. The baseband processor of claim 10, wherein the processing circuitry is configured further to:
generate an uplink control message including an indication of the value of the timer, the uplink control message to be transmitted to a base station (BS).

16. One or more non-transitory computer-readable media having instructions that are to be executed to cause processing circuitry to:
receive a configuration to enable stopping a timer based on a condition or buffer delay information associated with a stored packet data unit (PDU);
generate the PDU from one or more data units associated with an uplink transmission, the PDU is to be transmitted to a base station (BA) in the uplink transmission;
starting the timer;
storing the PDU in a hybrid automatic repeat request (HARQ) buffer; and
stopping the timer based on the buffer delay information of the one or more data units in the PDU.

17. The one or more non-transitory computer-readable media of claim 16, wherein the timer is a configured grant timer, a discontinuous reception (DRX) retransmission timer for uplink, or a DRX round trip time timer for uplink.

18. The one or more non-transitory computer-readable media of claim 16, wherein the configuration includes an indication of a logical channel (LCH), and the condition includes:
the PDU includes a data unit from the LCH; or
the data unit in one or more data units is associated with a PDU set with an importance level smaller than a threshold or not associated with the importance level.

19. The one or more non-transitory computer-readable media of claim 16, wherein the buffer delay information is to include:
a delivery deadline of a data unit of the one or more data units in the PDU;
a remaining time until a delivery deadline of the data unit of the one or more data units in the PDU; or
a shortest or a longest remaining time until the delivery deadline of the data unit of the one or more data units in the PDU.

20. The one or more non-transitory computer-readable media of claim 16, wherein the instructions are to be executed to further cause the processing circuitry to:
generate an uplink control message including an indication of stopping the timer, the uplink control message to be transmitted to a base station (BS).
